(19) United States
(12) Patent Application Publication
(10) Pub. No.: US 2003/0038392 A1
(43) Pub. Date: Feb. 27, 2003

(54) Process and device for the batchwise production of polyurethane slabstock foam

(76) Inventors: Rolf Weber, Bad Honnef (DE); Horst Klahre, Sankt Augustin (DE); Lothar Rohrig, Neunkirchen (DE); Bernd Schlieperskotter, Neunkirchen (DE)

Correspondence Address: BAYER CORPORATION, PATENT DEPARTMENT, 100 BAYER ROAD, PITTSBURGH, PA, 15205, US

(21) Appl. No.: 10/224,058

(22) Filed: Aug. 20, 2002

(30) Foreign Application Priority Data
Aug. 24, 2001 (DE) 10141619.9

(51) Int. Cl. B29C 44/00

(52) U.S. Cl. 264/51; 425/4 R

(57) ABSTRACT

Slabstock foam may be produced, in particular in larger dimensions, in homogeneous form and with less waste, by introducing a foam-forming reaction mixture into a stationary moulding box, transporting a mobile foaming station (preferably on guide means) over the molding box, curing the foaming reaction mixture, optionally under defined pressure conditions, transporting the foaming station away from the molding box, and, demolding and removing the slab of foam from the molding box.

### BACKGROUND OF THE INVENTION

This invention relates to a process and to an apparatus for the batchwise production of polyurethane slabstock foam from at least two free-flowing reaction components, wherein these reaction components are mixed and introduced into a molding box and the reaction mixture is allowed to foam in a foaming station, wherein the resultant slab of foam is subsequently demolded and removed.

Batchwise production of polyurethane slabstock foam is always selected when continuous production is not worthwhile. This is the case when only small quantities are involved, and in particular, when producing slabs of speciality foam.

In the simplest case, the reaction mixture is produced in a mixer, is discharged into a mobile molding box and the reaction mixture is allowed to foam to yield the slab. This is, of course, very time-consuming and does not generally meet the requirements for the production of slabstock foam with specific properties.

An improved method of performing the known process or the embodiment of the apparatus as described in, for example, DE 198 48 148 A1), accordingly provides that the molding box is mobile and is pushed into a foaming station which assumes the form of a pressure chamber. This pressure chamber is closable with a sealing door plate such that the foaming process may be influenced while the mixture is foaming by application of an increased or reduced pressure of a defined level and duration. The foaming station is moreover preferably provided with a lid, the weight of which is, at least in part, counterbalanced, and which may be lowered to a defined level or horizontal position in the molding box.

The disadvantage of this process is that, when introducing the mobile or slidable molding box into the stationary foaming station or pressure chamber, the reaction mixture charged into the molding box rapidly starts to slosh, thus causing curtaining. This sloshing or curtaining, in turn, results in disrupted homogeneity in the foam slab, and thus results in lower grade foam or, in some cases, it even results in reject foam. Rapid movement of the molding box is often necessary because the box must reach the foaming station or pressure chamber before the cream time of the reaction mixture has elapsed. The shorter the cream time of the reaction mixture before the onset of the reaction, the greater the risk of sloshing and curtaining. This risk in particular applies when producing slabstock foams in which toluene diisocyanate (TDI) is used as a reaction component. Moreover, the size of the molding box is limited by the period until the reaction mixture starts to react because all the reaction mixture must be charged into the molding box and the molding box must be introduced into the foaming station within this period of time. Using previously known means, molding boxes having internal dimensions of up to approximately 2.25×2.1×1.5 m may be used for the production of ordinary grades of foam. In this case, the reaction mixture to be charged has a volume of approximately 150 liters or a weight of approximately 160 to 170 kg. For most applications, such as, for example, for mattresses, the slabstock foam produced must also be trimmed on all sides, which is a cause of considerable further wastage.

### SUMMARY OF THE INVENTION

The object of the present invention is to a provide a process and an apparatus with which homogeneous polyurethane slabstock foam can be produced with less waste. In particular, it is desirable to provide a process for the production and an apparatus suitable for this process which result in relatively large foam slabs.

This object is achieved by introducing the reaction mixture into a stationary molding box, running (e.g. moving or otherwise transporting) the foaming station over the molding box and not running (e.g. moving or otherwise transporting) it back away from the molding box until the foam has cured.

By making the foaming station mobile and making the molding box stationary at least during filling and curing, the risk of sloshing and curtaining of the reaction mixture, which results in non-homogeneity of the foam slab, are avoided. Moreover, larger slabs may be produced because the foaming station may be transported (i.e. run) more rapidly over the molding box than the molding box could previously be transported (i.e. run) into the foaming station. The time saved can be used to charge more reaction mixture into the molding box. Finally, when producing larger foam slabs, the level of waste from trimming is also lower. This measure of decreased waste levels was not obvious because success was not predictable, and because the consequently required new or additional device features ran contrary to the normal trend of development.

### BRIEF DESCRIPTION OF THE DRAWINGS

FIG. 1 is a side view of a cross-section through the apparatus according to the invention with the foaming station run back away from the molding box and the molding box in the stationary position with the charging and/or mixing device positioned inside the molding box.

FIG. 2 is a top perspective view of one embodiment of the apparatus according to the invention. In FIG. 2, one possible layout is illustrated for positioning of the foaming station and the molding boxes in relationship to the conveyors for moving the molding boxes to and from the stationary position.

FIG. 3 is a side view of a cross-section through the apparatus according to the invention with the filled molding box, the mixing device being moved out of the molding box, and the foaming station running over the molding box.

FIG. 4 is a side view of a cross-section through the apparatus of the invention wherein the foaming station sealingly encloses the molding box.

### DETAILED DESCRIPTION OF THE INVENTION

On embodiment of the process of the present invention for the batchwise production of polyurethane slabstock foam comprises:

(1) charging a reaction mixture comprising at least two free-flowing reaction components into a molding box which is in a stationary position,

(2) transporting a foaming station over the molding box,

(3) allowing the reaction mixture in the molding box to foam while the molding box is in the foaming station,

(4) curing the foam,

(5) transporting the foaming station away from the molding box,

(6) opening the molding box, and

(7) demolding the resultant slab of foam from the molding box.

Another particular embodiment of the present process for the production of polyurethane slabstock foam is characterized by two or more molding boxes being circulated through the basic steps as identified above. More specifically, this embodiment comprises:

(1) positioning a first molding box in a stationary position,

(2) charging a reaction mixture comprising at least two-free flowing reaction components into the first molding box,

(3) transporting a foaming station over the first molding box,

(4) allowing the reaction mixture in the first molding box to foam while in the foaming station,

(5) curing the foam,

(6) transporting the foaming station away from the first molding box,

(7) laterally displacing the first molding box,

(8) opening the first molding box,

(9) demolding the resultant slab of foam from the first molding box,

(10) preparing the first molding box for re-charging with the reaction mixture,

(11) repeating steps (1) through (10) with a second molding box, and, optionally,

(12) repeating steps (1) through (10) with one or more subsequent molding boxes.

In this alternate embodiment which requires more than one molding box, the first molding box may be transported or circulated back to the stationary position for filling with reaction mixture, and the remaining steps repeated.

The present invention, as previously discussed, requires that the foaming station be movable and each of the molding boxes be in a stationary position at the time of filling and foaming. The foaming station can be run over the molding box and back away from the molding box. In the embodiment that requires at least two molding boxes, the molding boxes can be laterally displaced from the stationary position where filling/foaming occurs by a suitable transporting means, preferably a conveyor, and the next molding box can be placed in the stationary position for filling/foaming.

After curing of the slab of foam is complete, the slab of foam is demolded from the molding box. This typically requires opening of the molding box, and grabbing and removing of the foam slab. The emptied molding box is then prepared for the next filling.

Circulation of two or more molding boxes in any case rationalizes production by increasing throughput. Production may be automated at some points, as is known in comparable circulation methods, for example, for molds. Whether and at what point production is automated is primarily determined by production costs, i.e., in particular by wage costs.

The new process steps are, in principle, independent of the degree of rationalization. The necessary quantity of reaction mixture is produced in a mixing device, the mixing device has preferably been lowered into the particular molding box to be filled, and the mixture is charged into the stationary molding box. Once the appropriate or desired quantity of mixture has been charged, the mixing device is raised back up (assuming it was lowered into the molding box), and the molding station runs over the stationary molding box which is filled with foam forming reaction mixture. Once the foam slab has cured, the foaming station runs back, so exposing the molding box again. The molding box may then be displaced laterally. While the next molding box is being placed in the position of the preceding one, the filled molding box is opened, which generally proceeds by folding down or splaying apart the four side walls. The foam slab is then picked up by grabs and removed. Then, the emptied molding box is prepared for the next filling. Apart from the filling and foaming station and the emptying station, the position or station at which preparation proceeds is in principle immaterial, but it does depend upon the structure of the device or apparatus. Preparation of the emptied molding box for the next filling comprises removing any possibly adhering foam residues and relining the molding box with paper or PE film in order to prevent foam adhesion. Instead of lining the mold, simply brushing the contact surfaces of the molding box with a suitable mold release agent is sufficient for many kinds of foam.

Curing of the foam is preferably performed in a sealed foaming station under a defined pressure.

This measure has the advantage that the foam forming process can be influenced by applying a certain increased or reduced pressure.

According to a particular embodiment of the new process, an optionally counterbalanced lid is introduced into the molding box before curing, said lid being removed again before the molding box is opened and/or before the foam is demolded.

In this manner, it is ensured that the optionally counterbalanced lid may be lowered to a predetermined level, specifically to a level such that it lies upon the still liquid reaction mixture or such that the rising foam does not come into contact with the lid until it has reached a higher level and it then carries the lid on upwards. The degree of counterbalancing may preferably be adjusted or be modified during curing. The contact surface of the lid facing towards the foam must also be coated with a release agent before each foaming operation. It is also possible, although more complicated, to apply a new release sheet of paper or polyethylene onto this surface in each instance.

The new apparatus for the batchwise production of polyurethane slabstock foam from at least two free-flowing reaction components which form the polyurethane foam when mixed comprises a charging/mixing device, at least one molding box, and a foaming station that can be run back and forth over the one molding box. The charging/mixing device is positioned vertically above the molding box when the molding box is in the stationary position where it is filled with reaction mixture. The charging/mixing device can be moved vertically up and down so as to prevent splashing of the reaction mixture being placed/charged in the molding box, and to not interfere with the foaming station being run back and forth over the molding station.

The novelty of this presently claimed process and apparatus lies in the fact that the molding box is stationary, that the mixing device is arranged thereover and that the foaming station is mobile and may be run over the molding box, and back away from the foaming station.

The advantages discussed above in relation to the new process are consequently achieved. The new configuration of the apparatus for the production of slabstock foam is somewhat more costly than the known stationary foaming station with a mobile molding box, but this is offset by the advantages of the new process. Naturally, displacement or movement of the foaming station generally proceeds by a suitable drive means.

The foaming station is preferably associated with guide means.

Suitable guide means for the foaming station include, for example, rails for rollers which are fitted or suitably attached to the foaming station. Sliding guide means for the foaming stations are, however, also possible.

The new foaming apparatus is preferably characterized by two or more molding boxes, and a conveyor (e.g. track or belt) to circulate them through the phases/steps.

When the process and apparatus have two or more molding boxes, one advantage is of increased throughput capacity. Filling of one molding box and curing of the foam, on the one hand, and demolding and removal of the foam slab produced and preparing the emptied molding box for the next filling, on the other, can occur or proceed at the same time. Roller conveyors with at least some driven rollers are preferably used as the conveyor track. Since circulation of the molding boxes generally proceeds around a rectangle, rollers are required at the corner points which are arranged at 90° angles, and are, optionally, temporarily retractable, so that the molding boxes may in each case be conveyed onwards transversely. Pusher bars are also conceivably used and may thus be located at the corner points instead of driven rollers. Draw bars or cables are less suitable due to the corners, but still possible.

The foaming station is preferably provided with a lowerable, and optionally counterbalanced lid.

The lid which can be raised and lowered vertically, and which is optionally counterbalanced, makes it possible to produce slabs of foam having with a virtually flat upper surface. The distance between the lid and the walls of the molding box should be such that, even if slightly incorrectly positioned, the lid does not come into contact with the walls and that the expelled air can escape through the gap.

According to another preferred embodiment of the new apparatus for producing slabstock foam, a base plate is present in a position such that it lies horizontally under the stationary position where the molding box is filled/charged. At or near one end of the base plate, an end plate is vertically positioned and the end plate has a seal. The end plate is located at the opposite vertical end of the molding box from the foaming station. The foaming station has an opening on the vertical end closest to the molding box, to enable the molding box to be received inside the foaming station. When the foaming station is run over the molding box (i.e. when the molding box is received inside the foaming station), the foaming station contacts the seal on the end plate and, together with the base plate, forms a pressure chamber which sealingly encloses the molding box and the base plate. The foaming station only has an opening on the side closest to, i.e. in the direction of, the molding box.

This development permits the possibilities already discussed in connection with the new process.

In the run back state of the foaming station or pressure chamber, the base plate preferably extends into said foaming station (or pressure chamber) and is mounted displaceably on the floor of the foaming station.

In this manner, it is ensured that the base plate is mounted at both ends. On the one hand, it is mounted movably on the floor of the foaming station (or pressure chamber) and, on the other, fixed to the end plate. Mobility on the base plate is ensured by rollers, but a sliding surface or slide rails are also possible.

Reference will now be made to the drawings. These drawings are purely schematic diagrams of one embodiment of the new apparatus which is described in greater detail below.

FIG. 1 is a side-view of a cross-section through the apparatus according to the invention with the foaming station run back away from the molding box and the molding box in the stationary position is ready to be filled with the reaction mixture from the charging and/or mixing device which is positioned inside the molding box.

FIG. 2 is a top perspective view of the apparatus according to FIG. 1.

FIG. 3 is side-view of a cross-section through the apparatus according to the invention with the filled molding box and the foaming station running over the molding box.

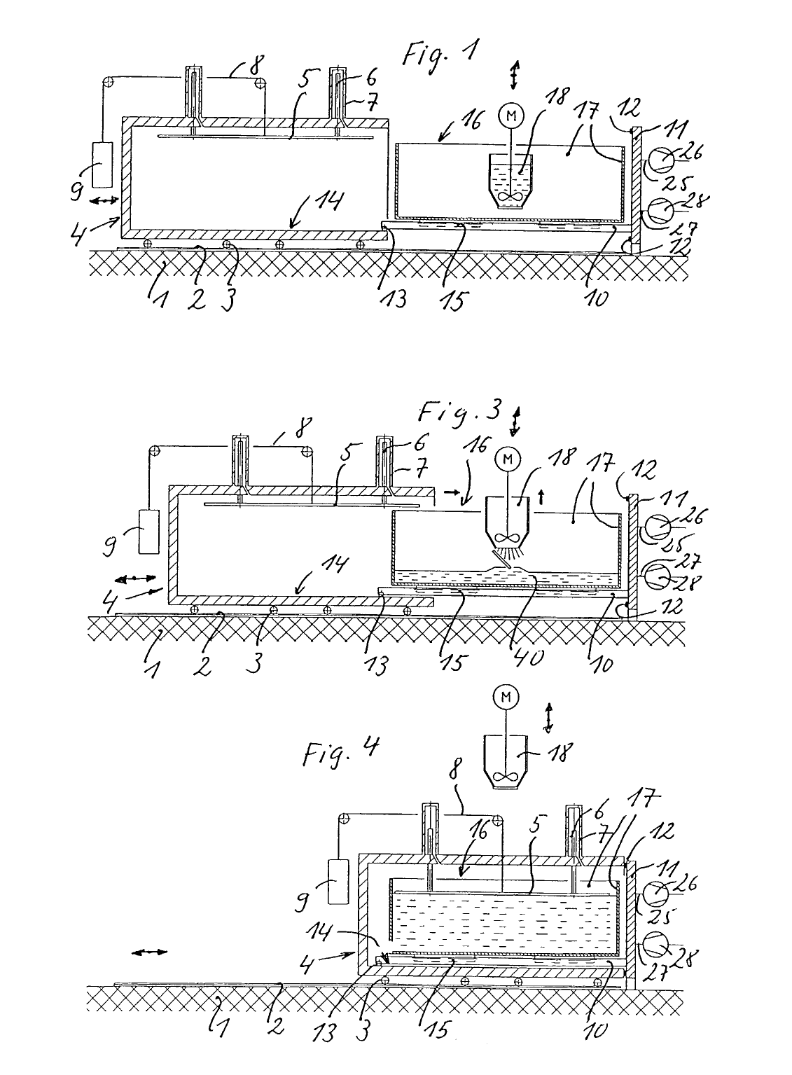

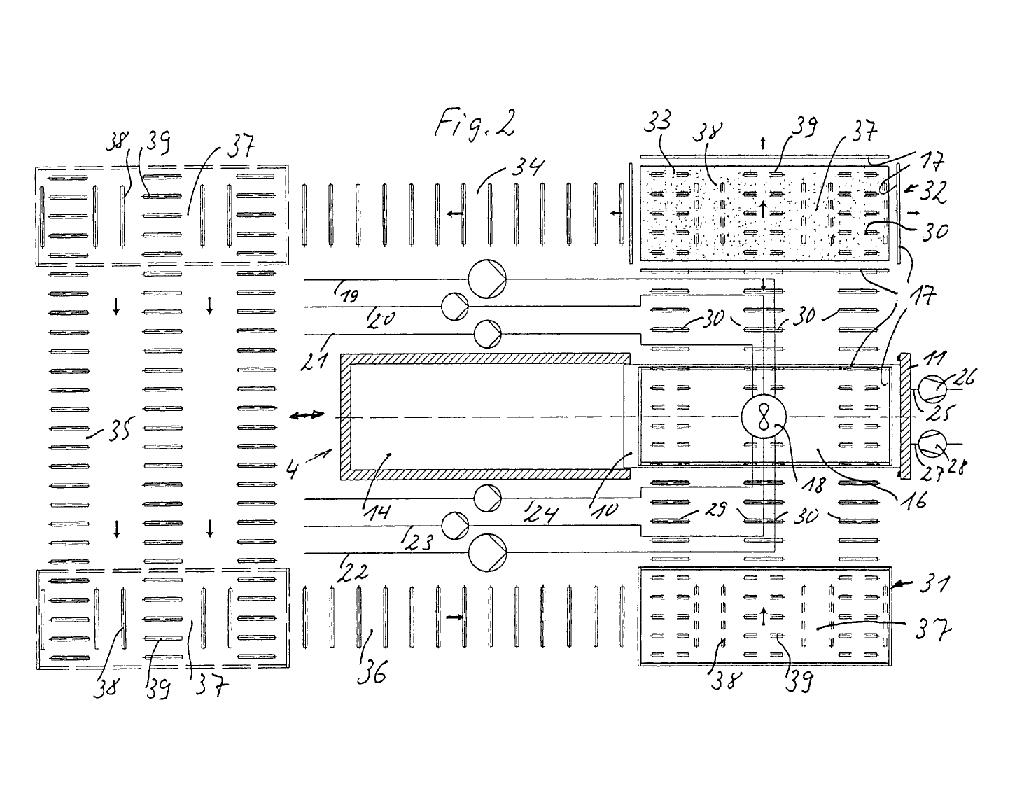

FIG. 4 is a side-view of a cross-section through the apparatus according to the invention wherein the molding box is sealingly enclosed in the foaming station.

In FIG. 1, the apparatus is arranged on a foundation 1, which has guide means 2 which take the form of rails. On these guide means 2, rest the rollers 3 of a mobile foaming station 4 which is movable on the guide means 2 and assumes the form of a pressure chamber 4. The drive means of the foaming station 4 are not shown, but are represented symbolically as an arrow. A lid 5 is mounted by means of bars 6 in vertical guides 7 of the foaming station 4. The lid 5 is partially counterbalanced with a counterweight 9 via a cable 8. A base plate 10 is combined with an end plate 11, on which resides a seal 12 which corresponds in size and shape to the foaming station 4 or pressure chamber 4. The suction port 25 of a vacuum pump 26 and the pressure port 27 of a compressor 28 open through the end plate 11. Whatever the position of the mobile foaming station 4, the other end (i.e. the end opposite of the end plate 11) of the base plate 10 extends in the foaming station 4 and is mounted with rollers 13 on the floor 14 of the foaming station 4. The base plate 10 is provided with drivable rollers 15, on which a molding box 16 is stationary. The molding box 16 has side walls 17 which can be folded down or splayed apart on all sides, and a floor, i.e. a base wall which lies horizontally and connects to the bottom of the side walls 17. The necessary stops for the temporary stationary positioning of the molding box 16 on the base plate 10 are not shown. These stops are removable (or retractable) for the purposes of transporting the molding box 16 onto and away from the base plate 10. A lowerable mixing device 18 is arranged above the molding box 16. This mixing device 18 has a means (not shown) for being lowered into and raised out of the molding box 16.

In FIG. 2, a polyol feed line 19 leads to the mixing device 18, as well as feed lines 20, 21 for additives, a feed line 22 for isocyanate as well as further feed lines 23, 24 for additives. The suction port 25 of a vacuum pump 26 and the pressure port 27 of a compressor 28 open through the end plate 11. The lower edge of the vertical end plate 11 is connected to one end of a horizontal base plate 10. The opposite end of the base plate 10 extends into the foaming station 4, and is mounted onto the floor 14 of the foaming station 4 in a manner that allows the foaming station 4 to be run over and run away from the molding box 16 which is in the stationary position. Drivable roller conveyors 29, 30, assuming the form of conveyor tracks, are arranged on each side of the stationary molding box 16. A second molding box 31 is located on the roller conveyor 29, said molding box 31 being lined with PE film (not shown) for filling. A third molding box 32 is located on the roller conveyor 30, the side walls of which molding box 32 are splayed apart, such that the finished slab of foam 33 can be picked up and removed by a grab device (not shown) once the side walls 17 have been lifted up. Further roller conveyors 34, 35, 36 acting as drivable conveyor tracks to ensure that the molding boxes 16, 31, 32 can be circulated. In each of the corner positions 37, retractable rollers 38, 39, some of which are drivable, are arranged offset at an angle of 90°, so that the molding boxes 16, 31, 32 can be conveyed onwards in the other direction at these corner positions 37 in each case without being rotated.

In FIG. 3, the apparatus is arranged on a foundation 1, which has guide means 2 which take the form of rails. On these guide means 2, rest the rollers 3 of a mobile foaming station 4 which is movable on the guide means 2 and assumes the form of a pressure chamber 4. The drive means of the foaming station 4 are not shown, but are represented symbolically as an arrow. A lid 5 is mounted by means of bars 6 in vertical guides 7 of the foaming station 4. The lid 5 is partially counterbalanced with a counterweight 9 via a cable 8. A base plate 10 is combined with an end plate 11, on which resides a seal 12 which corresponds in size and shape to the foaming station 4 or pressure chamber 4. The suction port 25 of a vacuum pump 26 and the pressure port 27 of a compressor 28 open through the end plate 11. Whatever the position of the mobile foaming station 4, the other end (i.e. the end opposite of the end plate 11) of the base plate 10 extends in the foaming station 4 and is mounted with rollers 13 on the floor 14 of the foaming station 4. The base plate 10 is provided with drivable rollers 15, on which a molding box 16 is stationary. The molding box 16 has side walls 17 which can be folded down or splayed apart on all sides, and a floor, i.e. a base wall which lies horizontally and connects to the bottom of the side walls 17. The necessary stops for the temporary stationary positioning of the molding box 16 on the base plate 10 are not shown. These stops are removable (or retractable) for the purposes of transporting the molding box 16 onto and away from the base plate 10. The mixing device 18 is being withdrawn from the molding box 16 after charging the still liquid reaction mixture 40 into the molding box 16, and the foaming station 4 (or pressure chamber 4) is being run over the molding box 16.

In FIG. 4, the apparatus is arranged on a foundation 1, which has guide means 2 which take the form of rails. On these guide means 2, rest the rollers 3 of a mobile foaming station 4 which is movable on the guide means 2 and assumes the form of a pressure chamber 4. The drive means of the foaming station 4 are not shown, but are represented symbolically as an arrow. A lid 5 is mounted by means of bars 6 in vertical guides 7 of the foaming station 4. The lid 5 is partially counterbalanced with a counterweight 9 via a cable 8. A base plate 10 is combined with an end plate 11, on which resides a seal 12 which corresponds in size and shape to the foaming station 4 or pressure chamber 4. The suction port 25 of a vacuum pump 26 and the pressure port 27 of a compressor 28 open through the end plate 11. Whatever the position of the mobile foaming station 4, the other end (i.e. the end opposite of the end plate 11) of the base plate 10 extends in the foaming station 4 and is mounted with rollers 13 on the floor 14 of the foaming station 4. The base plate 10 is provided with drivable rollers 15, on which a molding box 16 is stationary. The molding box 16 has side walls 17 which can be folded down or splayed apart on all sides, and a floor, i.e. a base wall which lies horizontally and connects to the bottom of the side walls 17. The necessary stops for the temporary stationary positioning of the molding box 16 on the base plate 10 are not shown. These stops are removable (or retractable) for the purposes of transporting the molding box 16 onto and away from the base plate 10. The mixing device 18 has been lifted up. The foaming station 4 or pressure chamber 4 is positioned such that the open end contacts and seals with the seal 12 on the end plate 11, and thus encloses the molding box 16. The lid 5 is still resting on the foam slab 33 which was produced in the molding box 16 within the foaming station 4 or the pressure chamber 4.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the batchwise production of polyurethane slabstock foam comprising
(1) charging a reaction mixture comprising at least two free-flowing reaction components into a molding box which is in a stationary position,
(2) transporting a foaming station over the molding box,
(3) allowing the reaction mixture in the molding box to foam in the foaming station,
(4) curing the foam,
(5) transporting the foaming station away from the molding box,
(6) opening the molding box, and
(7) demolding the resultant slab of foam from the molding box.

2. A process for the batchwise production of polyurethane slabstock foam, comprising:
(1) positioning a first molding box in a stationary position,
(2) charging a reaction mixture comprising at least two-free flowing reaction components into the first molding box,
(3) transporting a foaming station over the first molding box,
(4) allowing the reaction mixture in the first molding box to foam in the foaming station,
(5) curing the foam,
(6) transporting the foaming station away from the first molding box,
(7) laterally displacing the first molding box,
(8) opening the first molding box,
(9) demolding the resultant slab of foam from the first molding box,
(10) preparing the first molding box for re-charging with the reaction mixture,
(11) repeating steps (1) through (10) with a second molding box, and optionally,
(12) repeating steps (1) through (10) with one or more subsequent molding boxes.

3. The process of claim 2, wherein steps (1) through (10) are repeated with the first molding box.

4. The process of claim 1, wherein (4) curing is performed in a sealed foaming station under a defined pressure.

5. The process of claim 2, wherein (5) curing is performed in a sealed foaming station under a defined pressure.

6. The process of claim 1, additionally comprising introducing a counterbalanced lid into the molding box prior to (4) the curing step, and removing the counterbalanced lid prior to (6) opening the molding box.

7. The process of claim 2, additionally comprising introducing a counterbalanced lid into the molding box prior to (5) the curing step, and removing the counterbalanced lid prior to (8) opening the molding box.

8. An apparatus for the batchwise production of polyurethane slabstock foam from at least two free-flowing, polyurethane-forming reaction components, comprising a mixing device, at least one molding box, and a foaming station for at least one molding box, wherein the molding box is in a stationary position with the mixing device positioned above the molding box, and the foaming station is mobile and may moved to a position such that the molding box is enclosed in the foaming station.

9. The apparatus of claim 8, additionally comprising a means for transporting the foaming station to and from the molding box.

10. The apparatus of claim 8, additionally comprising a means for guiding the foaming station to and from the molding box.

11. The apparatus of claim 8, wherein there are two or more molding boxes, and additionally comprising a means for circulating the molding boxes into the stationary position under the mixing device and away from the stationary position.

12. The apparatus of claim 11, wherein the means for circulating is selected from the group consisting of at least one conveyor belt and at least one conveyor track.

13. The apparatus of claim 8, wherein the foaming station additionally comprises a lid which is movable in the vertical direction.

14. The apparatus of claim 13, wherein the lid is counterbalanced.

15. The apparatus of claim 8, additionally comprising a base plate positioned horizontally under the molding box in the stationary position, an end plate positioned vertically at or near one end of the base plate, said end plate having a sealing means, and said foaming station, which is located at the opposite vertical end of the molding box, having an opening on the vertical end closest to said molding box for receiving said molding box, wherein a pressure chamber is formed by positioning said foaming station such that the opening contacts said sealing means on said end plate, and together with said base plate sealingly encloses said molding box in said pressure chamber.

16. The apparatus of claim 15, wherein said base plate extends into said foaming station when said foaming station is moved away from said molding box, and said base plate is displacably mounted on the interior surface of the floor of said foaming station.
